(19) United States
(12) Patent Application Publication
(10) Pub. No.: US 2026/0273676 A1
(43) Pub. Date: Sep. 17, 2026

(54) GEARED ROTARY TABLE

(71) Applicant: PARKSON WU INDUSTRIAL CO., LTD., Taichung City (TW)

(72) Inventor: Ming Hsi Wu, Taichung City (TW)

(21) Appl. No.: 19/078,735

(22) Filed: Mar. 13, 2025

(51) Int. Cl. B23Q 1/54

(52) U.S. Cl. CPC B23Q 1/5418; B23Q 2220/004

(57) ABSTRACT

A geared rotary table includes a base, a spindle mechanism, a work plate, a clutch gear mechanism, and a drive mechanism. The spindle mechanism is disposed in the base and located above a support portion of the base, and is driven by the drive mechanism to rotate. The work plate is coupled to the spindle mechanism. The clutch gear mechanism is fitted on the spindle mechanism. When an upper clutch gear of the clutch gear mechanism is moved upward, the work plate is driven to rotate simultaneously during machining. When the upper clutch gear is moved downward to engage with a first lower clutch gear and a second lower clutch gear of the clutch gear mechanism, the work plate is immovable during machining.

### FIELD OF THE INVENTION

The present invention relates to a rotary table, and more particularly, to a geared rotary table.

### BACKGROUND OF THE INVENTION

A rotary table is an essential accessory for milling machines, primarily used in CNC machines, grinding machines and various specialized machines. Rotary tables are required for milling various gears, polygons, and splines. The cutting force varies depending on the material of a workpiece and the required milling structure.

A conventional rotary table is braked by a drive motor of a rotary drive mechanism to limit the rotation of the rotary table for a workpiece to be milled. However, heavy cutting will exert a significant force on the workpiece. Relying solely on the braking of the drive motor is insufficient to fix the rotational position of the rotary table, which may cause displacement during cutting and affect cutting accuracy.

### SUMMARY OF THE INVENTION

The primary object of the present invention is to provide a geared rotary table. When an upper clutch gear of a clutch gear mechanism is pushed in the direction of gravity to engage with a first lower clutch gear and a second lower clutch gear, in cooperation with a support portion to support the clutch gear mechanism, the stability of the engagement positioning is improved to ensure that the rotary table will not deviate from the cutting position due to the cutting force during gravity cutting, and the probability of generating tolerances in the clutch gear mechanism after long-term use is reduced.

In order to achieve the foregoing object, the present invention provides a geared rotary table, comprising a base, a spindle mechanism, a work plate, a clutch gear mechanism, and a drive mechanism.

The base has a support portion and a mounting space extending in an axial direction above the support portion.

The spindle has a spindle portion and a spindle head coaxially disposed on one end of the spindle portion opposite the support portion. The spindle portion defines a first outer diameter D1, and the spindle head defines a head outer diameter D3 greater than the first outer diameter D1.

The work plate is coupled to the spindle mechanism for placement of a workpiece.

The clutch gear mechanism is coaxially sleeved on the spindle portion between the spindle head and the support portion. The clutch gear mechanism includes an upper clutch gear, a first lower clutch gear, and a second lower clutch gear. The first lower clutch gear is secured on the support portion. The second lower clutch gear is disposed around an outer periphery of the first lower clutch gear and locked to a bottom of the spindle seat. The upper clutch gear is movable up and down along the spindle portion and located above the first lower clutch gear and the second lower clutch gear.

The drive mechanism is connected to the spindle mechanism in a transmission manner for driving the spindle mechanism to rotate.

When the upper clutch gear is selectively moved upward along the spindle portion away from the first lower clutch gear and the second lower clutch gear, the spindle mechanism is in a first machining state and is driven by the drive mechanism to rotate, and the work plate is driven to rotate simultaneously during machining. When the upper clutch gear is selectively moved downward along the spindle portion to engage with the first lower clutch gear and the second lower clutch gear and exert a force on the first lower clutch gear and the second lower clutch gear towards the support portion, the spindle mechanism is in a second machining state and cannot be driven to rotate by the drive mechanism so that the work plate is immovable during machining.

### BRIEF DESCRIPTION OF THE DRAWINGS

FIG. 1 is an exploded view of the present invention;

FIG. 2 is a side sectional view of the present invention, illustrating outer diameters of the spindle portion, the stepped portion and the spindle head of the spindle; and

FIG. 3 is a top sectional view of the present invention.

### DETAILED DESCRIPTION OF THE PREFERRED EMBODIMENTS

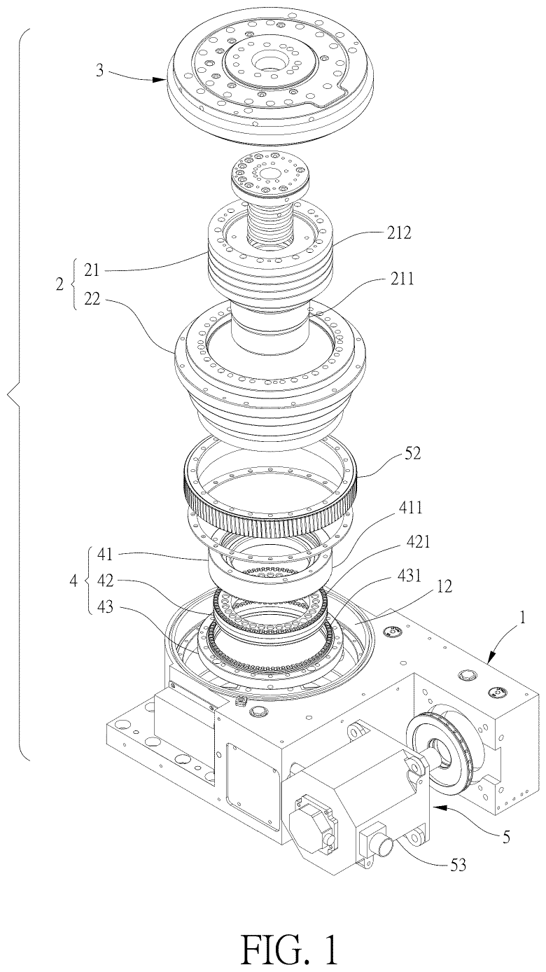

As shown in FIG. 1 through FIG. 3, a geared rotary table according to a preferred embodiment of the present invention comprises a base 1, a spindle mechanism 2, a work plate 3, a clutch gear mechanism 4, and a drive mechanism 5.

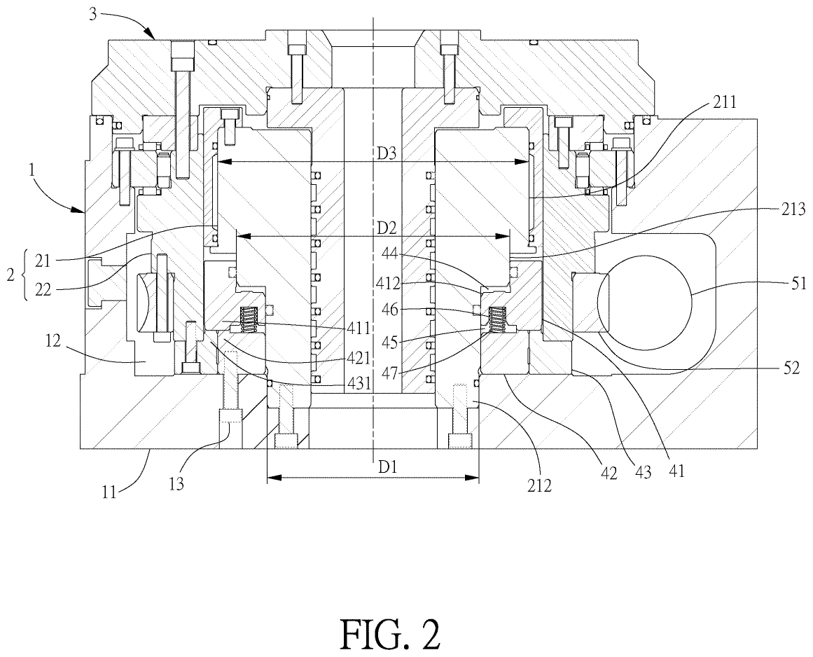

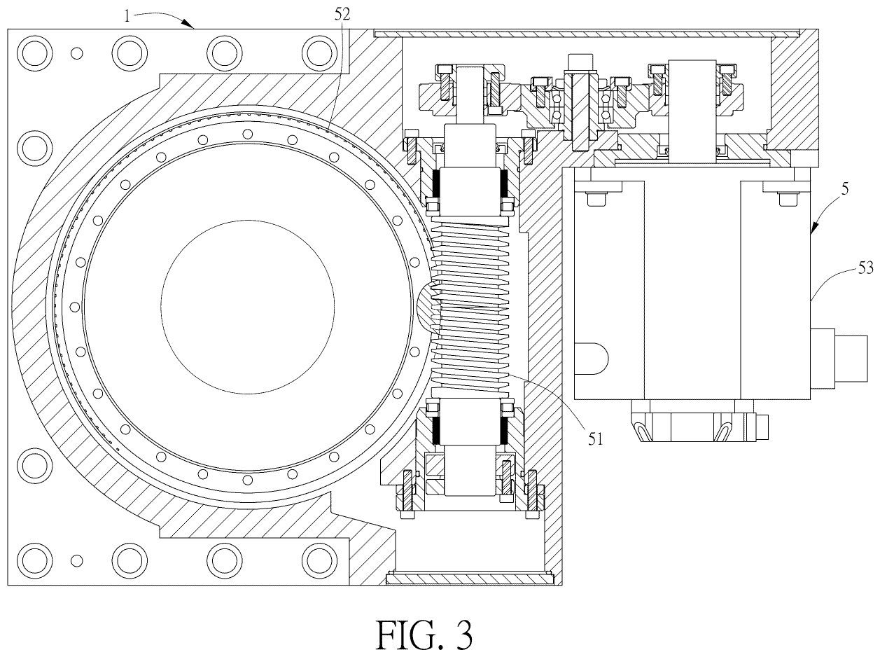

As shown in FIG. 1 and FIG. 2, the base 1 has a support portion 11 and a mounting space 12 extending in an axial direction above the support portion 11. The spindle mechanism 2 is coaxially disposed in the mounting space 12. The spindle mechanism 2 includes a spindle 21 and a spindle seat 22 coaxially sleeved on the outer periphery of the spindle 21. The work plate 3 is locked to one end of the spindle 21 and the spindle seat 22 opposite the support portion 11, such that the work plate 3 is coupled to the spindle mechanism 2 for placement of a workpiece. The spindle mechanism 2 is driven by the drive mechanism 5 to drive the work plate 3 to rotate together. In this embodiment, as shown in FIG. 3, the drive mechanism 5 includes a worm 51 and a worm wheel 52 matching with the worm 51. The worm wheel 52 is fitted on the outer periphery of the spindle seat 22. The worm 51 is driven by a motor 53 to rotate and mesh with the worm wheel 52, so that the spindle mechanism 2 drives the work plate 3 to rotate together. Preferably, the worm 51 is a two-stage worm, so as to adjust and reduce the backlash between the worm 51 and the worm wheel 52. In other feasible implementations, the drive mechanism 5 may be a roller cam mechanism or a direct drive mechanism which is directly powered by a direct drive motor.

The spindle 21 has a spindle portion 211 and a spindle head 212 coaxially disposed on one end of the spindle portion 211 opposite the support portion 11. The clutch gear mechanism 4 is coaxially sleeved on the spindle portion 211 between the spindle head 212 and the support portion 11. As shown in FIG. 2, the spindle portion 211 defines a first outer diameter D1, and the spindle head 212 defines a head outer diameter D3. The head outer diameter D3 is greater than the first outer diameter D1. The clutch gear mechanism 4 is coaxially sleeved on the spindle portion 211 between the spindle head 212 and the support portion 11. The clutch gear mechanism 4 includes an upper clutch gear 41, a first lower clutch gear 42, and a second lower clutch gear 43. The first lower clutch gear 42 is locked on the support portion 11. The top of the first lower clutch gear 42 has a plurality of spaced first lower gear teeth 421 arranged in a ring. The first lower gear teeth 421 are located close to the outer periphery of the first lower clutch gear 42. The second lower clutch gear 43 is disposed around the outer periphery of the first lower clutch gear 42 and is locked to the bottom of the spindle seat 22. The top of the second lower clutch gear 43 has a plurality of spaced second lower gear teeth 431 arranged in a ring. The second lower gear teeth 431 are located close to the inner periphery of the second lower clutch gear 43 and are adjacent to the first lower gear teeth 421. The bottom of the upper clutch gear 41 has a plurality of spaced upper gear teeth 411 arranged in a ring. The upper clutch gear 41 is selectively moved downward toward the first lower clutch gear 42 and the second lower clutch gear 43, so that the upper gear teeth 411 are engaged with the first lower gear teeth 421 and the second lower gear teeth 431; alternatively, the upper clutch gear 41 is selectively moved upward away from the first lower clutch gear 42 and the second lower clutch gear 43, so that the upper gear teeth 411 are disengaged from the first lower gear teeth 421 and the second lower gear teeth 431.

Furthermore, one side of the spindle head 212, adjacent to the spindle portion 211, is recessed radially inwardly to form a stepped portion 213. The stepped portion 213 defines a second outer diameter D2. The first outer diameter D1 of the spindle portion 211, the second outer diameter D2 of the stepped portion 213, and the head outer diameter D3 of the spindle head 212 satisfy a relationship of D1<D2<D3. The upper clutch gear 41 has a protrusion 412 extending radially toward the spindle portion 211 and corresponding in position to the bottom of the stepped portion 213, such that an oil passage space 44 is formed between the stepped portion 213 and the protrusion 412. The oil passage space 44 is in fluid communication with an external device (not shown), in this embodiment, the external device is a hydraulic device (not shown). A return space 45 is formed between the protrusion 412 and the first lower clutch gear 42. A plurality of mounting grooves 46 facing the first lower clutch gear 42 are formed in the bottom of the protrusion 412. A plurality of return springs 47 each having one end inserted in a corresponding one of the mounting grooves 46 and another end against the top of the first lower clutch gear 42 are secured in the return space 45. In particular, the volume of the oil passage space 44 is less than that of the return space 45. Compared with the conventional geared rotary table, only a small amount of hydraulic oil needs to be injected into the oil passage space to push the upper clutch gear 41 downward. After the hydraulic device is depressurized, the return springs 47 generate an elastic return force to push the upper clutch gear 41 upward to discharge the hydraulic oil from the oil passage space 44. Compared with the conventional geared rotary table, there is no need to inject hydraulic oil to push the return springs, thereby realizing quick switching of the machining state of the spindle mechanism 2.

When the hydraulic oil of the hydraulic device (not shown) does not enter the oil passage space 44, the upper clutch gear 41 is pushed by the return springs 47 to disengage from the first lower clutch gear 42 and the second lower clutch gear 43. At this time, the spindle mechanism 2 is in a first machining state, allowing the work plate 3 to rotate simultaneously during machining. The work plate 3 can be braked by the drive mechanism 5. This is suitable for synchronized machining and high-precision machining.

When the hydraulic oil of the hydraulic device (not shown) enters the oil passage space 44, the upper clutch gear 41 is pushed to move downward and compress the return springs 47 in the return space 45, and the upper clutch gear 41 continuously exerts a force on the first lower clutch gear 42 and the second lower clutch gear 43 towards the support portion 11, such that the upper gear teeth 411 of the upper clutch gear 41 are tightly engaged with the first lower gear teeth 421 of the first lower clutch gear 42 and the second lower gear teeth 431 of the second lower clutch gear 43. The spindle mechanism 2 is in a second machining state and cannot be driven to rotate by the drive mechanism 5, so that the work plate 3 is immovable during machining. This is suitable for heavy cutting that requires a strong braking force.

Further, the first lower clutch gear 42 is locked to the support portion 11 by a screw element 13 extending from the support portion 11 toward the spindle head 212. The locking direction of the screw element 13 is opposite to the direction of force exerted on the first lower clutch gear 42 and the second lower clutch gear 43. When the upper clutch gear 41 is moved downward, the support portion 11 withstands the force exerted by the upper clutch gear 41, which is opposite to the locking force of the screw element 13, thereby stabilizing the overall structural stability of the present invention and making it less prone to tolerances in long-term use.

Based on the above, the geared rotary table provided by the present invention can achieve the following improved effects:

Firstly, the fixing manner of the work plate can be changed to meet different machining needs. In the present invention, the clutch gear mechanism is selectively disengaged from the spindle mechanism so that the spindle mechanism is in the first machining state and can be driven by the drive mechanism to drive the work plate to rotate simultaneously during machining, meeting the needs of synchronized machining and high-precision machining; alternatively, the clutch gear mechanism is selectively engaged with the spindle mechanism so that the spindle mechanism is in the second machining state and cannot be driven to rotate by the drive mechanism, and the work plate is immovable during machining, meeting the needs of heavy cutting that requires a strong braking force.

Secondly, the disengagement braking effect is excellent and meets the requirement of machining accuracy. In the clutch gear mechanism of the present invention, the upper clutch gear is pushed downward by hydraulic oil to engage with the first lower clutch gear and the second lower clutch gear to brake the spindle mechanism, and the direction of thrust on the upper clutch gear is the same as the direction of gravity, which makes the engagement braking effect better. In cooperation with the braking of the drive mechanism, the work plate is not easy to deviate during heavy cutting, meeting the requirement of machining accuracy.

Thirdly, the structure is not easy to produce tolerance after long-term use. The support portion of the base of the present invention supports the clutch gear mechanism, which provides support for the first lower clutch gear and the second lower clutch gear when they are pushed. Besides, the first lower clutch gear is locked to the support portion by the screw element, which confines the mounting positions of the first lower clutch gear and the second lower clutch gear, ensuring that the structure is not prone to tolerance after long-term use.

Fourthly, the structure is optimized to improve the switching efficiency of the manner to secure the work plate. In the present invention, the oil passage space is formed between the upper clutch gear and the spindle head, and the return space is formed between the upper clutch gear and the first lower clutch gear. The return springs are disposed in the return space for elastic return, instead of injecting hydraulic oil for return, which reduces the use of hydraulic oil and improves the return efficiency.

1. A geared rotary table, comprising:
a base, having a support portion and a mounting space extending in an axial direction above the support portion;
a spindle mechanism, coaxially disposed in the mounting space, the spindle mechanism including a spindle and a spindle seat coaxially sleeved on an outer periphery of the spindle, the spindle having a spindle portion and a spindle head coaxially disposed on one end of the spindle portion opposite the support portion, the spindle portion defining a first outer diameter, and the spindle head defining a head outer diameter greater than the first outer diameter;
a work plate, coupled to the spindle mechanism for placement of a workpiece;
a clutch gear mechanism, coaxially sleeved on the spindle portion between the spindle head and the support portion, the clutch gear mechanism including an upper clutch gear, a first lower clutch gear and a second lower clutch gear, the first lower clutch gear being secured on the support portion, the second lower clutch gear being disposed around an outer periphery of the first lower clutch gear and locked to a bottom of the spindle seat; the upper clutch gear being movable up and down along the spindle portion and located above the first lower clutch gear and the second lower clutch gear;
a drive mechanism, connected to the spindle mechanism in a transmission manner, for driving the spindle mechanism to rotate;
wherein when the upper clutch gear is selectively moved upward along the spindle portion away from the first lower clutch gear and the second lower clutch gear, the spindle mechanism is in a first machining state and driven by the drive mechanism to rotate so that the work plate is driven to rotate simultaneously during machining; when the upper clutch gear is selectively moved downward along the spindle portion to engage with the first lower clutch gear and the second lower clutch gear and to exert a force on the first lower clutch gear and the second lower clutch gear towards the support portion, the spindle mechanism is in a second machining state and cannot be driven to rotate by the drive mechanism so that the work plate is immovable during machining.

2. The geared rotary table as claimed in claim 1, wherein the drive mechanism includes a worm and a worm wheel matching with the worm, the worm wheel is fitted on an outer periphery of the spindle seat, and the worm is driven by a motor to rotate and mesh with the worm wheel so that the spindle seat drives the spindle to rotate together.

3. The geared rotary table as claimed in claim 1, wherein the drive mechanism is a roller cam mechanism.

4. The geared rotary table as claimed in claim 1, wherein the drive mechanism is a direct drive motor mechanism.

5. The geared rotary table as claimed in claim 1, wherein one side of the spindle head, adjacent to the spindle portion, is recessed radially inwardly to form a stepped portion, the stepped portion defining a second outer diameter, wherein the first outer diameter, the second outer diameter, and the head outer diameter satisfy a relationship of first outer diameter<the second outer diameter<the head outer diameter, the upper clutch gear has a protrusion extending radially toward the spindle portion; an oil passage space is formed between the protrusion and the stepped portion, a return space is formed between the protrusion and the first lower clutch gear; the oil passage space is in fluid communication with an external device, and a plurality of return springs are provided in the return space.

6. The geared rotary table as claimed in claim 5, wherein a bottom of the protrusion has a plurality of mounting grooves facing the first lower clutch gear, and the return springs each have one end inserted in a corresponding one of the mounting grooves and another end against a top of the first lower clutch gear so that the return springs are secured in the return space.

7. The geared rotary table as claimed in claim 5, wherein the oil passage space has a volume less than that of the return space.

8. The geared rotary table as claimed in claim 1, wherein the first lower clutch gear is locked to the support portion by a screw element extending from the support portion toward the spindle head, and a locking direction of the screw element is opposite to a direction of force exerted on the first lower clutch gear and the second lower clutch gear.
